(19) United States
(12) Patent Application Publication
(10) Pub. No.: US 2025/0013444 A1
(43) Pub. Date: Jan. 9, 2025

(54) COMPILER SYSTEMS AND METHODS OF EXTENDING EQUATION-BASED MODELING TO PROGRAMMING LANGUAGE INTERMEDIATE REPRESENTATIONS

(71) Applicant: JuliaHub, Inc., Boston, MA (US)

(72) Inventors: Yingbo Ma, Newton, MA (US); Christopher Rackauckas, Cambridge, MA (US)

(21) Appl. No.: 18/766,049

(22) Filed: Jul. 8, 2024

Related U.S. Application Data
(60) Provisional application No. 63/512,530, filed on Jul. 7, 2023.

(51) Int. Cl. G06F 8/41

(52) U.S. Cl. CPC G06F 8/4441

(57) ABSTRACT

Compiler systems and methods are described herein that retain structure to scale acausal models into large-scale models. They provide extensions to the algorithms and compiler to achieve both structure preservation and core passes of a stable acausal modeling compiler (alias elimination, index reduction, tearing, and code generation). Structure preservation is provided through programming language intermediate representations. A SSA-IR representation of the model is received, incidence information is computed via taint analysis, the Pantelides algorithm is extended to SSA-IR via bottom-up AD, alias elimination is extended to SSA-IR, tearing is extended to SSA-IR, and structure is regained through outlining passes on SSA-IR. Benefits of increasing speed and efficiency of code generation are provided.

### CROSS-REFERENCE TO RELATED APPLICATIONS

This application claims priority to U.S. Provisional Patent Application No. 63/512,530 (Attorney Docket No. 1207/13 PROV) filed on Jul. 7, 2023, entitled, “COMPILER SYSTEMS AND METHODS OF EXTENDING EQUATION-BASED MODELING TO PROGRAMMING LANGUAGE INTERMEDIATE REPRESENTATIONS,” the entire contents of which are incorporated by reference herein.

### TECHNICAL FIELD

The field of the invention relates generally to compiler systems and methods that extend equation-based modeling to programming language intermediate representations.

### BACKGROUND

In scientific computing, equation-based modeling approaches have gained popularity due to their ability to easily create large-scale models. In particular, acausal modeling systems have been found to improve the ability of scientists and engineers to accurately construct large models that can be simulated. See https://ieeexplore.ieee.org/document/4588514, http://www.physiome.cz/references/tcp2008.pdf. Causal modeling is a special case of acausal modeling, which is discussed in more detail below.

In particular, hierarchical component-based acausal modeling systems, such as Modelica, have become popular with scientists due to their ability to separate the process of constructing physically accurate components from the process of simulating connected models. However, there are two distinct concerns in the scaling of acausal modeling systems. One concern is the runtime of the generated code, while the other is the scaling of the compilation and code-generation process. Previous approaches have used single-static assignment intermediate representation (SSA-IR) to represent a Modelica compiler; however, these previous approaches either require loss of structure or flattening of the differential-algebraic equations (DAE) system in order to perform the compilation process, or omit many of the standard compilation passes of an acausal modeling compiler in order to achieve structure preservation. It would be advantageous to have compiler systems and methods that provide for efficient generation of code for scaling acausal models, as well as compiler systems and methods that provide for efficient runtime of the generated code for large-scale acausal models.

### SUMMARY

Compiler systems and methods are described herein that solve the above problems by retaining structure to scale acausal models into large-scale models. The compiler systems and methods described herein provide extensions to the algorithms and compiler to achieve both the structure preservation and the core passes of a stable acausal modeling compiler (alias elimination, index reduction, tearing, and code generation). As noted, there are two main concerns in the scaling of acausal modeling compilers. The first concern is the runtime of the generated code, which can take too long to run to be practicable. The second concern is the scaling of the compilation and code-generation process. The compiler systems and methods described herein provide structure preservation through programming language intermediate representations. This is accomplished by receiving a single-static assignment intermediate representation (SSA-IR) representation of the model, computing incidence information via taint analysis, extending the Pantelides algorithm to SSA-IR via bottom-up automatic differentiation, extending alias elimination to SSA-IR, extending tearing to linear SSA-IR, and regaining structure through outlining passes on SSA-IR. The compiler systems and methods described herein provide the benefit of increasing speed and efficiency of code generation, meaning that code for large-scale acausal models is generated significantly more quickly, as well as decrease the runtime of the generated code, which means that the generated code for large-scale acausal models runs significantly more quickly. Thus, the compiler systems and methods described herein generate new code that maintains the structure of the input code, and that code can be used for running the models. Each of these improvements leads to improved performance of large-scale acausal models and the processors or other computing systems on which those large-scale acausal models are executed, as explained in more detail below.

In an embodiment, a programmatic method for accelerating generation of code in a compiler that preserves structure of the code is disclosed. The method includes receiving a DAE system. The received DAE system is a causal model description or an acausal model description. The method further includes deriving structural information from the received DAE system. The derived structural information includes a bipartite graph of equations and variables. The method further includes generating a balanced index-1 DAE system. The method further includes generating a torn graph from the bipartite graph. The method further includes sorting the equations on the torn graph. The method further includes materializing the equations as source code for a programming language.

In another embodiment of the programmatic method for accelerating generation of code, the method further includes determining a linear subsystem from the model description. The method further includes using the determined linear subsystem to find alias variables or to use an exact Gaussian elimination method to simplify the linear subsystem. The method further includes sorting the alias variable on the torn graph.

In another embodiment of the programmatic method for accelerating generation of code, the method further includes compiling the materialized source code. The method may further include supplying a numerical solver with the compiled source code as the model to be solved.

In another embodiment of the programmatic method for accelerating generation of code, the received DAE system is received as a flattened system.

In another embodiment of the programmatic method for accelerating generation of code, the received DAE system is received as a hierarchical system.

In another embodiment of the programmatic method for accelerating generation of code, the received DAE system is represented in linear SSA-IR form.

In another embodiment of the programmatic method for accelerating generation of code, the programming language is in SSA-IR form.

In another embodiment of the programmatic method for accelerating generation of code, the balanced index-1 DAE system is generated using the Pantelides algorithm. The Pantelides algorithm may be array-based.

In another embodiment of the programmatic method for accelerating generation of code, the derived structural information further includes a variable differentiation graph.

In another embodiment of the programmatic method for accelerating generation of code, the generating a balanced index-1 DAE system is performed using bottom-up automatic differentiation.

In an embodiment, a compiler for accelerating generation of code is disclosed. The compiler includes one or more hardware processors. The one or more processors are configured for receiving a DAE system. The received DAE system is a causal model description or an acausal model description. The one or more processors are further configured for deriving structural information from the received DAE system. The derived structural information includes a bipartite graph of equations and variables. The one or more processors are further configured for generating a balanced index-1 DAE system. The one or more processors are further configured for generating a torn graph from the bipartite graph. The one or more processors are further configured for sorting the equations on the torn graph. The one or more processors are further configured for materializing the equations as source code for a programming language.

In another embodiment of the compiler for accelerating generation of code, the one or more hardware processors are further configured for determining a linear subsystem from the model description. The one or more hardware processors are further configured for using the determined linear subsystem to find alias variables or to use an exact Gaussian elimination method to simplify the linear subsystem. The one or more processors are further configured for sorting the alias variables on the torn graph.

In another embodiment of the compiler for accelerating generation of code, the one or more hardware processors are further configured for compiling the materialized source code. The one or more hardware processors may be further configured for supplying a numerical solver with the compiled source code as the model to be solved.

In another embodiment of the compiler for accelerating generation of code, the received DAE system is received as a flattened system.

In another embodiment of the compiler for accelerating generation of code, the received DAE system is received as a hierarchical system.

In another embodiment of the compiler for accelerating generation of code, the received DAE system is represented in linear SSA-IR form.

In another embodiment of the compiler for accelerating generation of code, the programming language is in SSA-IR form.

In another embodiment of the compiler for accelerating generation of code, the balanced index-1 DAE system is generated using the Pantelides algorithm. The Pantelides algorithm may be array-based.

In another embodiment of the compiler for accelerating generation of code, the derived structural information further includes a variable differentiation graph.

In another embodiment of the compiler for accelerating generation of code, the generating a balanced index-1 DAE system is performed using bottom-up automatic differentiation.

In an embodiment, a method for improved code generation performance and runtime efficiency for large-scale models of acausal systems is disclosed. The method includes using an extended Pantelides algorithm on an SSA-IR. The method further includes using extended alias elimination on the SSA-IR. The method further includes using an extended tearing algorithm on the SSA-IR. The method further includes generating code for sparse Jacobians via bottom-up automatic differentiation (AD). The method further includes using one or more SSA-IR outlining passes on a lowered acausal model to regain structure.

In another embodiment of the method for improved code generation performance and runtime efficiency for large-scale models of acausal systems, the SSA-IR representation on which the extended Pantelides algorithm is run is a linear SSA-IR.

In another embodiment of the method for improved code generation performance and runtime efficiency for large-scale models of acausal systems, the extended Pantelides algorithm is an array-based Pantelides algorithm.

In another embodiment of the method for improved code generation performance and runtime efficiency for large-scale models of acausal systems, the extended alias elimination is used on a linear SSA-IR.

In another embodiment of the method for improved code generation performance and runtime efficiency for large-scale models of acausal systems, the extended alias elimination is array-based.

In another embodiment of the method for improved code generation performance and runtime efficiency for large-scale models of acausal systems, the extended tearing algorithm is used on a linear SSA-IR.

In another embodiment of the method for improved code generation performance and runtime efficiency for large-scale models of acausal systems, the extended tearing algorithm is array-based.

In another embodiment of the method for improved code generation performance and runtime efficiency for large-scale models of acausal systems, the outlining passes are run before the entire intermediate representation is generated.

### BRIEF DESCRIPTION OF THE DRAWINGS

FIG. 1 depicts an RC-circuit example of an acausal model.

FIG. 2 depicts demonstrative code using ModelingToolkit to construct the RC-circuit of FIG. 1.

FIG. 3 depicts the full set of equations for the code shown in FIG. 2.

FIG. 4 depicts the simulation results for the RC-circuit of FIG. 1.

FIG. 5 depicts equations from the simplification process that allow for reconstructing observed variables that are not explicitly simulated.

FIG. 6 depicts a process that the standard Modelica compiler undergoes to scale an acausal model.

FIG. 7A depicts an exemplary process for accelerating code generation in a compiler.

FIG. 7B depicts an exemplary process for accelerating code generation in a compiler.

FIG. 8 depicts a block diagram illustrating one embodiment of a computing device for the systems and methods described herein.

### DETAILED DESCRIPTION

This summary is provided to introduce a selection of concepts in a simplified form that are further described below in the detailed description. This summary is not intended to identify key features or essential features of the claimed subject matter, nor is it intended to be used to limit the scope of the claimed subject matter.

An acausal model is defined in a high-level declarative form through equations and connections. Connection semantics on defined variable types allow a user to say that all connected variables must satisfy a given equation template. For example, “standard variables” connect via equality, where connect(a,b) implicitly defines the equation a=b.

Another common connection type is that of “flow variables,” where connect(a,b) implicitly defines the equation a+b=0.

If two connections exist within a model, then the connection semantics extends to combine the relationships. For example, connect(a,b) and connect(a,c) with standard variables generates the equations a=b=c, whereas connect(a,b) and connect(a,c) with flow variables creates the single relationship a+b+c=0.

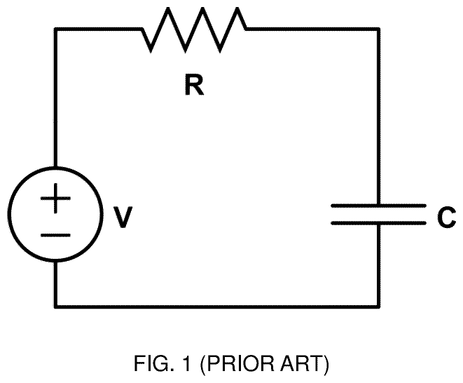

FIG. 1 depicts an RC-circuit example of an acausal model. A motivating example of an acausal model is the RC-circuit as shown in FIG. 1, which can be found at https://docs.sciml.ai/ModelingToolkit/stable/tutorials/acausal_components/. In an RC-circuit, such as the example shown in FIG. 1, voltages are standard variables and currents are flow variables, with the connections between electrical components thus specifying the equations of Kirchoff's Voltage Law and Kirchoff's Current Law, respectively.

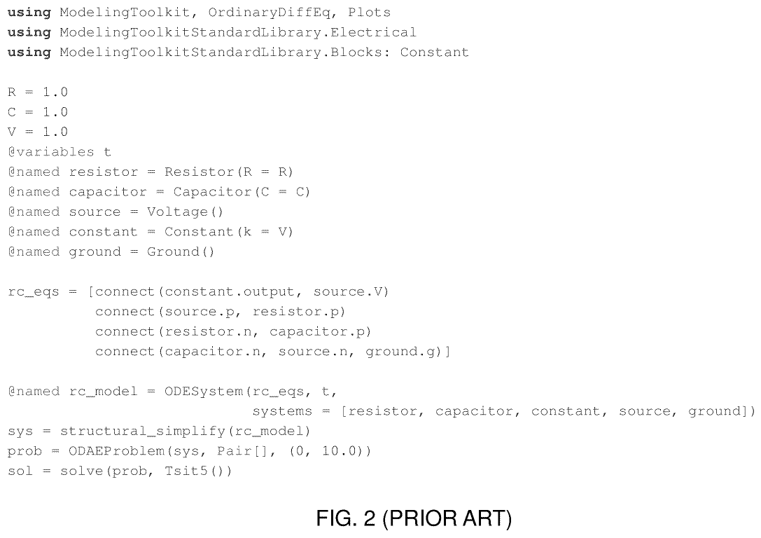

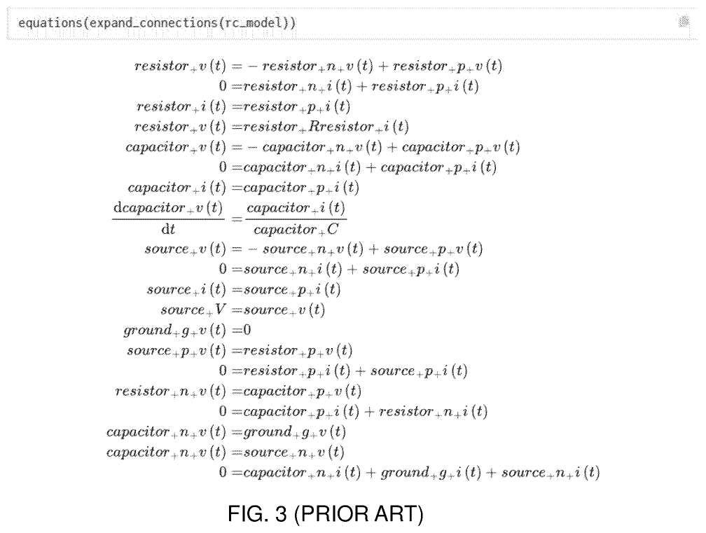

FIG. 2 depicts demonstrative code using the Julia scientific computing ModelingToolkit to construct the RC-circuit of FIG. 1. For this model, the full set of equations is shown in FIG. 3.

FIG. 3 depicts the full set of equations for the exemplary code shown in FIG. 2.

For simulation of an acausal model, it is often necessary for the compiler to perform a simplification of the model, for numerical purposes. Simplification of the model eliminates trivial equalities and performs more advanced transformations, such as the Pantelides algorithm, for index reduction to improve numerical stability. This is explained in more detail at https://ptolemy.berkeley.edu/projects/embedded/eecsx44/lectures/Spring2013/modelica-dae-part-2.pdf, https://ieeexplore.ieee.org/document/9240430, https://www.vehicular.isy.liu.se/Edu/Courses/Simulation/OH/dae4.pdf, and https://epubs.siam.org/doi/10.1137/0909014. After such a transformation, the demonstrative RC-circuit system of FIG. 1 reduces to a single ordinary differential equation (ODE), as shown here:

$$sys = structural\_simplify ( rc\_mode1 )$$

$$equations ( sys )$$

$$\frac{{dcapacitor}_{+} v ( t )}{dt} = \frac{{capacitor}_{+} i ( t )}{{capacitor}_{+} C}$$

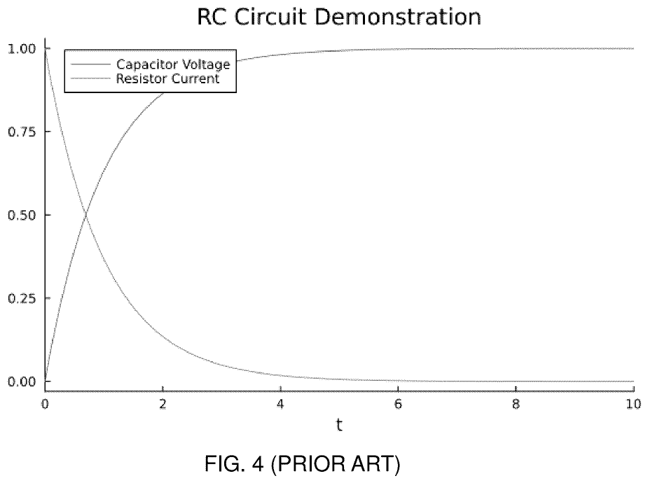

This single ODE is then simulated. FIG. 4 depicts simulation results for the RC-circuit of FIG. 1. Referring to FIG. 4, as the capacitor voltage rises and approaches 1, the resistor current falls and approaches 0.

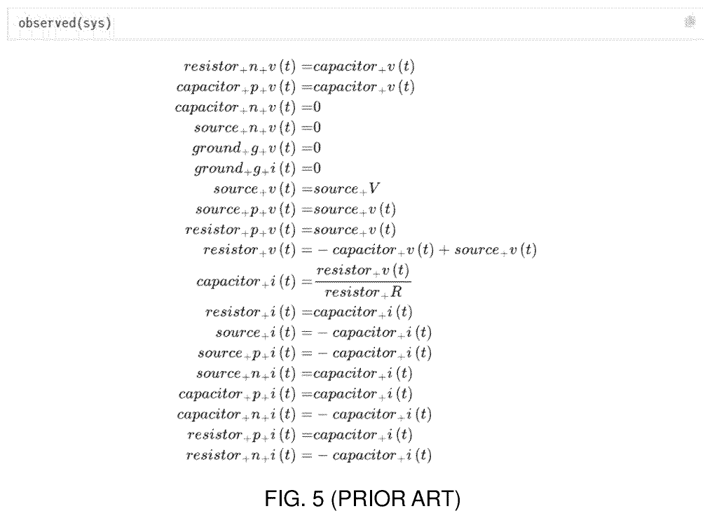

FIG. 5 depicts equations from the simplification process that allow for reconstructing observed variables that are not explicitly simulated. Observed variables are equations from the simplification process that allow for reconstructing variables that are not explicitly simulated.

Such an acausal modeling system makes a few assumptions on the way that components such as resistors and capacitors will be used, and thus have been found to help scale the construction of acausal models over other (causal) systems, as explained at https://www.sciencedirect.com/science/article/abs/pii/S0096300319307052.

### Scaling Acausal Modeling

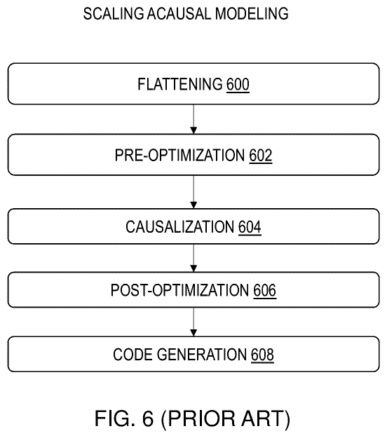

As noted in the Background section, because acausal modeling makes it easy for scientists and engineers to generate large-scale models, a major topic of concern in the tool-building community is the scaling of the simulation process to large-scale models. The standard Modelica compiler undergoes the following steps for scaling acausal models, which are depicted in FIG. 6.

FIG. 6 depicts a process that the standard Modelica compiler undergoes to scale an acausal model. This process is referenced, for example, in https://re.public.polimi.it/bitstream/11311/1065357/1/2017-BraunCasellaBachmann.pdf and https://re.public.polimi.it/bitstream/11311/964804/1/2015-Casella-Modelica.pdf). Referring to FIG. 6, the traditional process for scaling an acausal model includes flattening, pre-optimization, causalization, post-optimization, and code generation, each of which is described in more detail below.
(1) Flattening (Step 600). The Modelica model is transformed by the front-end into a flat representation, consisting essentially of lists of variables, functions, equations and algorithms.
(2) Pre-Optimization (Step 602). The Modelica model is then pre-optimized. In this phase, a basic structural analysis of the differential-algebraic equations (DAE) is performed. This includes, for example, detecting the potential states and discrete variables of the DAE, and eliminating alias variables.
(3) Causalization (Step 604). After pre-optimization, the DAE is then casualized. This is a basic step in a Modelica compiler, and is referred to as a BLT-Transformation. Matching, sorting, and index-reduction algorithms are applied to causalize the DAE and transform it to a system of ODEs.
(4) Post-Optimization (Step 606). After casualization, post-optimization is performed on the transformed system of ODEs. In this phase, further optimization processes are applied on the equation system. These further optimization processes include the optimization of algebraic loops, such as tearing, as well as the generation of corresponding symbolic Jacobians. Fully linear algebraic loops may also be identified and a linear solve inserted to optimize away the entire algebraic loop. Furthermore, this also may be applied to nonlinear equations, where a nonlinear solve is inserted inline. These optimizations can fully reduce DAEs into ODEs. The nonlinear solve insertion is an optional optimization that may not strictly improve the performance of the system.
(5) Code Generation (step 608). After the symbolic manipulation, the target code is generated for the optimized system to perform the simulation.

It is generally understood in the art that there are two main concerns in the scaling of acausal modeling compilers as described above. The first concern is the runtime of the generated code, which can take too long to run to be practicable. The second concern is the scaling of the compilation and code generation process. Much of the prior work on improving the scaling of the runtime assumes the unstructured scalarized flattened representation. This includes techniques such as (1) using sparse Jacobians; (2) tearing algorithms; (3) simulation in DAE mode; (4) multirate algorithms; (5) QSS algorithms; and (6) exploiting parallelization of CPUs. These techniques are detailed in https://re.public.polimi.it/bitstream/11311/964804/1/2015-Casella-Modelica.pdf and https://re.public.polimi.it/bitstream/11311/1065357/1/2017-BraunCasellaBachmann.pdf. However, it has been noted that the loss of this structure may be potentially leading to major performance losses from the start.

The compiler systems and methods described herein provide for improved scaling of acausal models by retaining the structure of the model representation, which allows for improved performance of the models at a large scale.

### Retaining and Regaining Structure in Code Generation of Acausal Models

Previous attempts to retain structure in acausal model code generation have previously been relegated to prototypes on subsets of the Modelica language. For example, https://ep.liu.se/ecp/043/104/ecp09430028.pdf attempted to avoid full flattening by preserving some repeated structures. The repeated structures were required to be causal components, as the method kept intact the standard Modelica lowering process, and thus it required causalization to be trivial in order for pre-optimization steps to be performed independently of the full model without flattening. However, it is noted that this technique can have many problems with DAE index reduction in the context of algebraic loops, which introduces more restrictions in its usage, and therefore the theoretical work never generated a working prototype. In another example, https://dl.acm.org/doi/abs/10.1145/2666202.2666207 attempted to improve the Pantelides algorithm to handle structural repetitions described by non-nested for loops, though it appears that a prototype was never generated. It worked by extending the Pantelides algorithm to a bipartite graph result for single for and deriving the a loop. https://2017.international.conference.modelica.org/proceedings/html/submissions/ecp17132565_OtterElmqvist.pdf describes extensions to the Pantelides algorithm that can retain array structures, such as matrix multiplication, with a Julia-based prototype called Modia (https://link.springer.com/chapter/10.1007/978-3-319-47169-3_15; https://2017.international. conference.modelica.org/proceedings/html/submissions/ecp17132693_ElmqvistHenningssonOtter.pdf. Notably, none of these techniques attempted to preserve general structures of programming languages, such as nested for loops or other control flow constructs.

Given the difficulty of structure retention, most of the field's efforts have since concentrated in regaining structure in the code-generation stage. For example, https://ep.liu.se/ecp/056/013/ecp1105613.pdf attempts to reduce the compilation by finding repeated blocks, performing separate compilation of said repeated blocks, and calling the compiled blocks in the generated code as needed. However, such a technique was only demonstrated on a toy language TinyModelica, which is a subset of Modelica that was specifically designed to be simple to handle with this technique. As another example, https://arxiv.org/abs/2212.11135 demonstrated the most complete technique, which used graph algorithms to perform array-aware matching and thus reconstruct array structures from flattened code, thereby achieving O(1) generated code in the case of simple array structures. However, this only works for capturing linear algebraic operations, such as matrix multiplication, and thus some operations like nonlinear convolutions of nonlinear PDEs can lead to non-O(1) behavior. Additionally, this method still relies on being able to represent the flattened system before restructuring the model, placing memory limitations on the compilation process.

A recent system, MARCO https://www.politesi.polimi.it/bitstream/10589/179218/1/Thesis.pdf, designed a Modelica compiler on the LLVM SSA-IR. It was able to demonstrate that using a programming language representation allowed for handling the compilation of some Modelica programs in a way that could retain O(1) generated code, and showcases that standard methods for automatic differentiation (forward and reverse mode AD) can be used to generate partial derivatives and system Jacobians used by numerical solvers from Modelica code. However, this work did not support the passes which are required for structural transformation of acausal models, noting “A high-index DAE cannot be solved directly, and must first be reduced to a DAE of index one. Such reduction can be performed through the Pantelides algorithm and the usage of dummy derivatives. These topics are outside the scope of this work and we won't see them in detail.” In addition, their FIG. 4.5 demonstrates the solving pipeline omits other standard Modelica passes like alias elimination and tearing. In contrast, the compiler systems and methods described herein substantially deviate from this effort by noting that the techniques from standard AD passes are incapable of efficiently handling the transformations required as part of index reduction, and handle the aspects of alias elimination and tearing which are required to receive stable simulations from most acausal model descriptions.

Thus, as shown above, previous approaches have used SSA-IR to represent a Modelica compiler; however, these previous approaches cither require loss of structure or flattening of the DAE system in order to perform the compilation process, or omit many of the standard compilation passes of an acausal modeling compiler in order to achieve structure preservation. The compiler systems and methods described herein provide extensions to the algorithms and compiler to achieve both the structure preservation and the core passes of a stable acausal modeling compiler (alias elimination, index reduction, tearing, and code generation).

### Alias Elimination and the Pantelides Algorithm

Most numerical methods for solving DAEs can only efficiently and accurately handle systems with a structural index of one. The Pantelides algorithm reduces the structural index of a DAE system to one, making it solvable using standard numerical methods. While the structural index is a weaker definition than the actual index, since structural index one is a necessary but not sufficient condition for index one, in the extended alias elimination the Bareiss algorithm (a form of Gaussian elimination with only exact integer operations) is performed to overcome this issue. Additionally, other forms of exact integer linear system simplification methods, such as Hermite Normal Form, may also be used for this step. In this context, the discrepancy typically only arises in linear connection equations that have +1/−1 coefficients. The Bareiss algorithm simplifies the integer linear subsystem, which helps bridge the gap between the structural index and the actual index, allowing the Pantelides algorithm to reduce the actual index of DAE systems to one. This is discussed in the following paper: https://2017.international.conference.modelica.org/proceedings/html/submissions/ecp17132565_OtterElmqvist.pdf.

To implement the Pantelides algorithm, a bipartite graph representing the incidence information of the DAE system and a differentiation graph of its variables are needed. The Pantelides algorithm then applies a matching algorithm to the bipartite graph to determine the minimum subset of equations that must be differentiated to lower the structural index of the DAE system. This process is repeated iteratively until the structural index is reduced to one, at which point the resulting index-one DAE system can be solved using standard numerical methods. While the Pantelides algorithm is a powerful tool for solving DAE systems, it is not guaranteed to work for all systems and can be computationally expensive for large systems. Nonetheless, it is widely used in acausal modeling.

While these manuscripts describe the alias elimination and index-reduction algorithms for deriving how a system should be transformed in a generic fashion, the compiler implementation of how these transformations should be instantiated on the representation of the model is not addressed. In the accompanying work, Modia, this is performed using symbolic manipulation of the system on the flattened models. In our work, we extend the instantiation of the transformation to be performed in a non-symbolic SSA-IR form, which allows for generalizing the algorithms to unflattened DAE systems and thus preserve structure and avoids the exponential blow up of the expression size. SSA makes the implementation of this transformation simpler though our work on eliminating the expression size blow up extends to any programming language intermediate language which features such as arrays and control flow.

### Tearing in Acausal Models

The tearing algorithm is an optimization technique that reduces the number of variables requiring numerical solving in a DAE system. The tearing algorithm achieves this by utilizing the bipartite graph and solvability information to identify a large acyclic-directed subgraph induced by solvable variables through a heuristic approach since optimal tearing is NP-hard. Because these variables are solvable and have no cyclic dependencies, the tearing pass can analytically solve them, thereby improving the speed of the numerical solving stage.

In acausal modeling, the tearing algorithm helps reduce the computational cost of DAE solvers. By minimizing the number of variables that need to be numerically solved, the algorithm significantly speeds up the DAE solving process.

While these manuscripts describe the tearing algorithm for deriving how a system should be transformed in a generic fashion, the compiler implementation of how these transformations should be instantiated on the representation of the model is not addressed. In the accompanying work, Modia, this is performed using symbolic manipulation of the system on the flattened models. In our work, we extend the instantiation of the transformation to be performed in a non-symbolic SSA-IR form, which allows for generalizing the algorithms to unflattened DAE systems and thus preserve structure.

### Automatic Differentiation vs Symbolic Differentiation and Algorithms for Retention of Programs

Generally, automatic differentiation (AD) may be thought of as symbolic differentiation that uses assignment (=) instead of using substitution. Let f(x) be an arbitrary function, which may be user-defined, for example. For example, for sin(f(x)), symbolic differentiation gives sin′(f(x))f′(x), and that expression is evaluated. But with automatic differentiation, code is generated that effectively does the following:
fx=f(x)
dfx=f′ (x)
sinx=sin(fx)
dsinx=cos(fx)
return dsinx*dfx

When calculating the derivative of a function, the function can be broken down into its component pieces, and for each fundamental operation there exists a rule for differentiating that fundamental operation. Each fundamental piece can be combined with the others using the chain rule, allowing for all pieces to be combined back together to create the derivative of the entire function. Automatic differentiation performs this breaking down, transformation into derivatives, and recomposition in an automatic and efficient manner.

### Differentiation of Languages

One way of describing the difference between symbolic differentiation and automatic differentiation is that symbolic differentiation is limited by the semantics of “standard mathematical expressions,” and AD is simply rewriting it in a language that allows for assignment. AD is symbolic differentiation in the language of SSA-IR, i.e., computer code.

“Symbolic differentiation” normally refers to differentiating in the language of mathematical expressions. For example, the Julia computing language package Symbolics.jl uses @variable x; f(x) to generate a mathematical expression without any computational aspects and then perform the differentiation in the context of the purely mathematical language. This is shown, for example, by the following Julia language code snippet:

```
using Symbolics
@variables x
function f(x)
  out = one(x)
  for i in 1:5
    out *= x\hat{ }i
  end
  out
end
sin(f(x)) # sin(x\hat{ }15)
```

Evaluation with symbolic variables completely removes the “non-mathematical” computational expressions, and then symbolic differentiation is performed in this language:

Symbolics.derivative(sin(f(x)),x)#15(x\hat{ }14)*cos(x\hat{ }15)

Note that this expression blows up. An entire computational expression is reduced to a single mathematical formula and differentiated using the chain rule, which then has the problem that it can exponentially blow up in the size of the expressions being built/differentiated. This is the downside of symbolic differentiation.

```
function f(x)
  out = x
  for i in 1:5
    out *= sin(out)
  end
  out
end
sin(f(x)) #
sin(x*sin(x)*sin(x*sin(x))*sin(x*sin(x)*sin(x*sin(x)))*sin(x*sin(x)*si
n(x*sin(x))*sin(x*sin(x)*sin(x*sin(x))))*sin(x*sin(x)*sin(x*sin(x))*si
n(x*sin(x)*sin(x*sin(x)))*sin(x*sin(x)*sin(x*sin(x))*sin(x*sin(x)*sin(
x*sin(x))))))
Symbolics.derivative(sin(f(x)),x) #
(sin(x)*sin(x*sin(x))*sin(x*sin(x)*sin(x*sin(x)))*sin(x*sin(x)*sin(x*s
in(x))*sin(x*sin(x)*sin(x*sin(x))))*sin(x*sin(x)*sin(x*sin(x))*sin(x*s
in(x)*sin(x*sin(x)))*sin(x*sin(x)*sin(x*sin(x))*sin(x*sin(x)*sin(x*sin
(x))))) +
x*cos(x)*sin(x*sin(x))*sin(x*sin(x)*sin(x*sin(x)))*sin(x*sin(x)*sin(x*
sin(x))*sin(x*sin(x)*sin(x*sin(x))))*sin(x*sin(x)*sin(x*sin(x))*sin(x*
sin(x)*sin(x*sin(x)))*sin(x*sin(x)*sin(x*sin(x))*sin(x*sin(x)*sin(x*si
n(x))))) + x*(sin(x)*sin(x*sin(x))*sin(x*sin(x)*sin(x*sin(x))) +
x*cos(x)*sin(x*sin(x))*sin(x*sin(x)*sin(x*sin(x))) +
x*(sin(x)*sin(x*sin(x)) + x*cos(x)*sin(x*sin(x)) + x*(x*cos(x) +
sin(x))*sin(x)*cos(x*sin(x)))*sin(x)*sin(x*sin(x))*cos(x*sin(x)*sin(x*
sin(x))) + x*(x*cos(x) +
sin(x))*sin(x)*cos(x*sin(x))*sin(x*sin(x)*sin(x*sin(x))))*sin(x)*sin(x
*sin(x))*sin(x*sin(x)*sin(x*sin(x)))*cos(x*sin(x)*sin(x*sin(x))*sin(x*
sin(x)*sin(x*sin(x))))*sin(x*sin(x)*sin(x*sin(x))*sin(x*sin(x)*sin(x*s
in(x)))*sin(x*sin(x)*sin(x*sin(x))*sin(x*sin(x)*sin(x*sin(x))))) +
x*(x*cos(x) +
sin(x))*sin(x)*cos(x*sin(x))*sin(x*sin(x)*sin(x*sin(x)))*sin(x*sin(x)*
sin(x*sin(x))*sin(x*sin(x)*sin(x*sin(x))))*sin(x*sin(x)*sin(x*sin(x))*
sin(x*sin(x)*sin(x*sin(x)))*sin(x*sin(x)*sin(x*sin(x))*sin(x*sin(x)*si
n(x*sin(x))))) + x*(sin(x)*sin(x*sin(x)) + x*cos(x)*sin(x*sin(x)) +
x*(x*cos(x) +
sin(x))*sin(x)*cos(x*sin(x)))*sin(x)*sin(x*sin(x))*cos(x*sin(x)*sin(x*
sin(x)))*sin(x*sin(x)*sin(x*sin(x))*sin(x*sin(x)*sin(x*sin(x))))*sin(x
*sin(x)*sin(x*sin(x))*sin(x*sin(x)*sin(x*sin(x)))*sin(x*sin(x)*sin(x*s
in(x))*sin(x*sin(x)*sin(x*sin(x))))) +
x*(sin(x)*sin(x*sin(x))*sin(x*sin(x)*sin(x*sin(x)))*sin(x*sin(x)*sin(x
*sin(x))*sin(x*sin(x)*sin(x*sin(x)))) +
x*cos(x)*sin(x*sin(x))*sin(x*sin(x)*sin(x*sin(x)))*sin(x*sin(x)*sin(x*
sin(x))*sin(x*sin(x)*sin(x*sin(x)))) + x*(sin(x)*sin(x*sin(x)) +
x*cos(x)*sin(x*sin(x)) + x*(x*cos(x) +
sin(x))*sin(x)*cos(x*sin(x)))*sin(x)*sin(x*sin(x))*cos(x*sin(x)*sin(x*
sin(x)))*sin(x*sin(x)*sin(x*sin(x))*sin(x*sin(x)*sin(x*sin(x)))) +
x*(x*cos(x) +
sin(x))*sin(x)*cos(x*sin(x))*sin(x*sin(x)*sin(x*sin(x)))*sin(x*sin(x)*
sin(x*sin(x))*sin(x*sin(x)*sin(x*sin(x)))) +
x*(sin(x)*sin(x*sin(x))*sin(x*sin(x)*sin(x*sin(x))) +
x*cos(x)*sin(x*sin(x))*sin(x*sin(x)*sin(x*sin(x))) +
x*(sin(x)*sin(x*sin(x)) + x*cos(x)*sin(x*sin(x)) + x*(x*cos(x) +
sin(x))*sin(x)*cos(x*sin(x)))*sin(x)*sin(x*sin(x))*cos(x*sin(x)*sin(x*
sin(x))) + x*(x*cos(x) +
sin(x))*sin(x)*cos(x*sin(x))*sin(x*sin(x)*sin(x*sin(x))))*sin(x)*sin(x
*sin(x))*sin(x*sin(x)*sin(x*sin(x)))*cos(x*sin(x)*sin(x*sin(x))*sin(x*
sin(x)*sin(x*sin(x)))))*sin(x)*sin(x*sin(x))*sin(x*sin(x)*sin(x*sin(x)
))*sin(x*sin(x)*sin(x*sin(x))*sin(x*sin(x)*sin(x*sin(x))))*cos(x*sin(x
)*sin(x*sin(x))*sin(x*sin(x)*sin(x*sin(x)))*sin(x*sin(x)*sin(x*sin(x))
*sin(x*sin(x)*sin(x*sin(x))))))*cos(x*sin(x)*sin(x*sin(x))*sin(x*sin(x
)*sin(x*sin(x)))*sin(x*sin(x)*sin(x*sin(x))*sin(x*sin(x)*sin(x*sin(x))
))*sin(x*sin(x)*sin(x*sin(x))*sin(x*sin(x)*sin(x*sin(x)))*sin(x*sin(x)
*sin(x*sin(x))*sin(x*sin(x)*sin(x*sin(x))))))
```

AD may be thought of as performing differentiation directly on the language of computer programs. When doing this, it is desirable to build expressions that carry forward the derivative calculation, and generate something that is a computation of the derivative, not a mathematical expression of it. On the same example described above, this looks like:

```
function f(x)
  out = x
  for i in 1:5
    # sin(out) => chain rule sin′ = cos
    tmp = (sin(out[1]), out[2] * cos(out[1]))
    # out = out * tmp => product rule
    out = (out[1] * tmp[1], out[1] * tmp [2] + out[2] * tmp[1])
  end
  out
end
function outer(x)
  # sin(x) => chain rule sin′ = cos
  out1, out2 = f(x)
  sin(out1), out2 * cos(out1)
end
dsinfx(x) = outer((x,1))[2]
f((1,1)) # (0.01753717849708632, 0.36676042682811677)
dsinfx(1) # 0.3667040292067162
```

Compare the above to the following:

julia> substitute(sin(f(x)),x=>1)
0.017536279576682495
julia> substitute(Symbolics.derivative(sin(f(x)),x),x=>1)
0.3667040292067162

The symbolic aspects can be seen in the above. The analytical derivative of sin being cos is used, and the product rule is used in the code that is generated. Those are the primitives. An extra variable is used to accumulate the derivative, because this is in the language of computer programs with for loops and operations, and the derivative of a computational expression is taken to get another computational expression.

The advantage is that things like control flow, which have no simple representation in mathematical language, have a concise computational description, so building the exponentially large mathematical expressions as described above can be avoided. As automatic differentiation is to symbolic differentiation, the compiler systems and methods described herein is to structure preservation in the generated code from acausal models, as opposed to the traditional Modelica code-generation process.

### Structure Preservation Through Programming Language Intermediate Representations

The compiler systems and methods described herein provide structure preservation or retain structure through programming language intermediate representations. In one embodiment, this is accomplished by receiving a linear SSA-IR representation of the programming language, computing an incidence matrix via taint analysis, extending the Pantelides algorithm to Linear SSA-IR via bottom-up automatic differentiation, extending alias elimination to Linear SSA-IR, extending tearing to Linear SSA-IR, and regaining structure through outlining passes on SSA-IR.

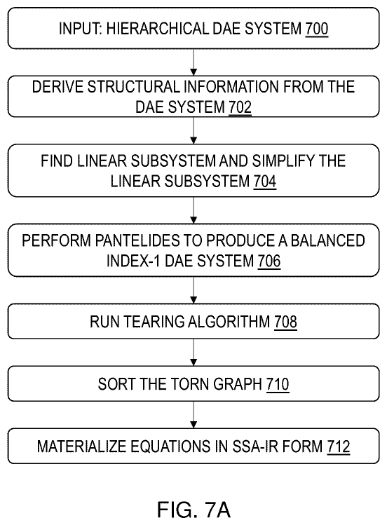

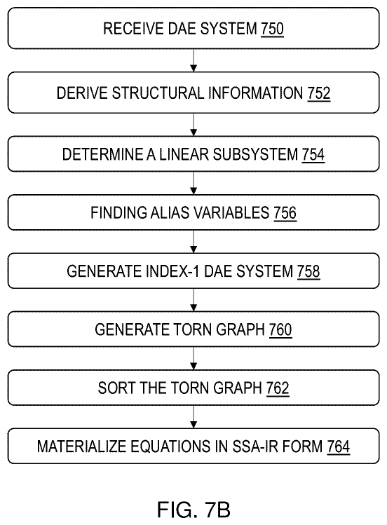

FIG. 7A depicts an exemplary process flow for implementing one embodiment of the compiler system and methods described herein. Referring to FIG. 7A, the following pseudocode represents the implementation of one embodiment of the compiler systems and methods described herein.

Input: hierarchical DAE system (step 700).
Derive the structural information from the DAE system (i.e., the bipartite graph of equations and variables and variable differentiation graph, as noted in the Pantelides paper, which is available at https://epubs.siam.org/doi/10.1137/0909014) (step 702).
Find linear subsystem with integer coefficients and use an exact Gaussian elimination method to simplify the linear subsystem (step 704).
Perform the Pantelides algorithm and use the dummy method to produce a balanced index-1 DAE system (https://www.researchgate.net/profile/Gustaf-Socderlind/publication/235324214_Index_Reduction_in_Differential-Algebraic_Equations_Using_Dummy_ Derivatives/links/56444cf908ac451880a71288/Index-Reduction-in-Differential-Algebraic-Equations-Using-Dummy-Derivatives.pdf) (step 706).
Run the tearing algorithm on the bipartite graph (https://elib.dlr.de/117431/1/Otter-transformation-of-differential.pdf) (step 708).
Topological sort the equations on the torn graph (step 710).
Materialize all the equations in the linear SSA IR form (step 712).

### (1) SSA-IR Representations of Programming Languages

Static single assignment form (commonly referred to as “SSA”) is commonly used as an intermediate representation (IR) for programming languages because it is easier to analyze, since each variable has only a single assignment. “Linear SSA-IR” represents programs in a linear sequence of expressions, and every argument of a function can only be an SSA value or constant, where an SSA value refers to a previous intermediate result that is also statically single assigned.

### (2) Incidence Information Computation via Taint Analysis

Statements that are if statements are handled via taking the intersection of the incidence vectors, and in cases like the Jacobian sparsity calculation, the union is taken. For more information, see https://openreview.net/pdf?id=rJlPdcY38B.

### (3) Extending the Pantelides Algorithm to Linear SSA-IR via Bottom-Up Automatic Differentiation

The compiler systems and methods described herein extend the Pantelides Algorithm to Linear SSA-IR via bottom-up automatic differentiation. As an example, describe using the Cartesian Pendulum system in two dimensions.

$$\frac{{dq}_{1} ( t )}{dt} = {v}_{1} ( t )$$

$$\frac{{dq}_{2} ( t )}{dt} = {v}_{2} ( t )$$

$$\frac{{dv}_{1} ( t )}{dt} = - {q}_{1} ( t ) λ ( t )$$

$$\frac{{dv}_{2} ( t )}{dt} = - g - {q}_{2} ( t ) λ ( t )$$

$${q}_{1} ( t ) = L sin ( θ ( t ) )$$

$${q}_{2} ( t ) = L cos ( θ ( t ) )$$

The Pantelides algorithm will differentiate the last equation twice to receive:

$$\frac{d θ ( t )}{dt} = {θ}_{t} ( t )$$

$$\frac{d {θ}_{t} ( t )}{dt} = {θ}_{tt} ( t )$$

$$0 = L {θ}_{tt} ( t ) cos ( θ ( t ) ) + L λ ( t ) sin ( θ ( t ) ) - {( {θ}_{t} ( t ) )}^{2} L sin ( θ ( t ) )$$

$$0 = g + L λ ( t ) cos ( θ ( t ) ) - {( {θ}_{t} ( t ) )}^{2} L cos ( θ ( t ) ) - L {θ}_{tt} ( t ) sin ( θ ( t ) )$$

It should be noted here that any algorithm for choosing what to change would also work. This includes other index-reduction algorithms.

Instead of performing symbolic differentiation, and thus substitution of the differentiated expressions into the final result, the compiler systems and methods described herein can, similar to automatic differentiation, exploit assignment in order to avoid symbolic differentiation. In this context, the Pantelides algorithm asserts that two derivatives of the last equation must be taken. A bottom-up automatic differentiation pass then generates the first and second derivative of the required output terms via automatic differentiation only on the subset of operations required to compute the necessary derivatives. In Linear SSA-IR, first all the dependencies of the last equation are found, and the chain rule is applied to each of the expressions to obtain the total time derivative of the last equation.

Thus, without substitution, the final representation of the index-lowered form can be described as:

$$\%1 = sin ( θ )$$

$$\%2 = cos ( θ )$$

$$\%3 = Dt ( θ , 1 , true )$$

$$\%4 = element ! ( \%3 , 1 )$$

$$\%5 = - ( \%1 )$$

$$\%6 = Dt ( θ , 2 , true )$$

$$\%7 = element ! ( \%6 , 2 )$$

$$\%8 = element ! ( ( ( L * ( ( ( \%5 * \%3 ) * \%3 ) + ( \%2 * \%6 ) ) ) - ( - ( ( L * \%1 ) ) * λ ) ) , 3 )$$

$$\%9 = element ! ( ( ( L * ( ( - ( ( \%2 * \%3 ) ) * \%3 ) + ( \%5 * \%6 ) ) ) - ( ( - ( ( L * \%2 ) ) * λ ) - g ) ) , 4 )$$

where “Dt(θ, 1, true)” and “Dt(θ, 2, true)” mean θ_t and θ_tt, and “element! (x, n)” means to write the result of “x” at the n-th position of the output array. Also, the above IR is contracted for readability, i.e., all constants and intermediate results that are not used at least twice are inlined.

Notably, this extends the Pantelides algorithm to all cases where the bottom-up subset is compatible with automatic differentiation. Similar to automatic differentiation, this algorithm retains structure and control flow.

### (4) Extending Alias Elimination to Linear SSA-IR

The alias elimination analysis pass returns the simplified linear system from the linear subsystem. To apply the simplification, the original equation is replaced with the simplified linear equation. For example, given the original equation 0=a−b+c, and the simplified linear equation 0=2a+c determined by Bareiss algorithm, the system can be optimized as follows. The system:

$$\%1 = a$$

$$\%2 = b$$

$$\%3 = c$$

$$\%4 = \%1 - \%2$$

$$\%5 = \%4 + \%3$$

which, is a−b+c, is optimized to:

$$\%1 = a$$

$$\%2 = c$$

$$\%3 = 2 * \%1$$

$$\%4 = \%3 + \%2$$

### (5) Extending Tearing to Linear SSA-IR

Tearing determines the solvable subsystem of an acausal model. Just like alias elimination, the solved variable can be assigned with the analytically solved result, e.g., given the system 0=2a+3, the symbolic algorithm would solve a=−3/2. With SSA-IR, the following program would be generated:

$$\%1 = a$$

$$\%2 = 2 * \%1$$

$$\%3 = \%2 + 3$$

$$\%4 = element ! ( \%3 , 1 )$$

$$...$$

The variable “a” can be solved analytically to arrive at:

$$\%1 = - 3$$

$$\%2 = \%1 / 2 \# a$$

$$...$$

This describes the tearing of linear subsystems, though it can be extended to nonlinear subsystems via embedding symbolic non-linear solving methods into the Linear SSA-IR.

### (6) Non-Symbolic Optimal Sparse Jacobian Evaluations via Bottom-Up AD

The standard method for generating sparse Jacobians is achieved by first specifying the sparsity pattern of the Jacobian and then using graph coloring to minimize the number of function evaluations required to form the entire Jacobian. However, not only is optimal graph coloring NP-complete, but color-assisted differentiation is also non-optimal even if the graph coloring itself is optimal because the evaluation granularity is constrained to the whole function.

Bottom-up AD is a form of AD that performs a program transformation dependent on the required derivative outputs. Given the outputs which must be differentiated in the program, a dependency analysis is performed in order to analyze which other expressions must be differentiated and then a subset of the original program transformed by the AD pass to compute the required subset of output derivatives.

Standard coloring-based AD implementations for sparse Jacobians use the AD transformation of the whole program, which can be non-optimal. Symbolic Jacobians, formed via bottom-up AD, naturally address the sparsity of Jacobians, and since the evaluation granularity is down to scalar computation, the optimization passes of the IR can easily optimize the computation to its full potential.

Here is the sparse Jacobian Linear SSA-IR of the Cartesian pendulum example from above:

$$\%1 = Dt ( θ , 1 , true )$$

$$\%2 = Dt ( θ , 2 , true )$$

$$\%3 = cos ( θ )$$

$$\%4 = - ( \%3 )$$

$$\%5 = ( \%4 * \%1 )$$

$$\%6 = sin ( θ )$$

$$\%7 = - ( \%6 )$$

$$\%8 = ( \%7 * \%1 )$$

$$\%9 = element ! ( ( ( L * ( ( \%7 * \%2 ) + ( \%5 * \%1 ) ) ) - ( - ( ( L * \%3 ) ) * λ ) ) , CartesianIndex ( 3 , 1 ) )$$

$$\%10 = element ! ( ( ( L * ( ( \%4 * \%2 ) + ( - ( \%8 ) * \%1 ) ) ) - ( - ( ( L * \%7 ) ) * λ ) ) , CartesianIndex ( 4 , 1 ) )$$

$$\%11 = element ! ( 1 , CartesianIndex ( 1 , 2 ) )$$

$$\%12 = element ! ( ( L * ( \%8 + \%8 ) ) , CartesianIndex ( 3 , 2 ) )$$

$$\%13 = element ! ( ( L * ( \%5 - ( \%3 * \%1 ) ) ) , CartesianIndex ( 4 , 2 ) )$$

$$\%14 = element ! ( ( L * \%6 ) , CartesianIndex ( 3 , 3 ) )$$

$$\%15 = element ! ( ( L * \%3 ) , CartesianIndex ( 4 , 3 ) )$$

$$\%16 = element ! ( 1 , CartesianIndex ( 2 , 4 ) )$$

$$\%17 = element ! ( ( L * \%3 ) , CartesianIndex ( 3 , 4 ) )$$

$$\%18 = element ! ( ( L * \%7 ) , CartesianIndex ( 4 , 4 ) )$$

$$\%19 = ( L * \%7 )$$

### (7) Regaining Structure Through Outlining Passes on SSA-IR

In large-scale models, equations or similarly structured expressions are repeated many times. Outlining passes can be performed on the Linear SSA-IR and those repeated expressions re-rolled into loops. This allows for regaining the structure and minimizing later compile time and runtime. Standard algorithms for outlining SSA-IR can be found at https://lists.llvm.org/pipermail/llvm-dev/2017-July/115666.html and https://github.com/llvm/llvm-project/blob/f3b5fca12a1c6d24d4198dde7db6e93332a0e085/llvm/lib/Analysis/IRSimilarityIdentifier.cpp.

### EXAMPLE

$$\%1 = x \qquad Input$$

$$\%2 = 0.1$$

$$\%3 = 3$$

$$\%4 = ( \%1 \hat{} \%3 )$$

$$\%5 = ( \%2 * \%4 )$$

$$\%6 = ( \%1 + \%5 )$$

$$\%7 = sin ( \%6 )$$

$$\%8 = ( \%7 \hat{} \%3 )$$

$$\%9 = ( \%2 * \%8 )$$

$$\%10 = ( \%7 + \%9 )$$

$$\%11 = sin ( \%10 )$$

$$\%12 = ( \%11 \hat{} \%3 )$$

$$\%13 = ( \%2 * \%12 )$$

$$\%14 = ( \%11 + \%13 )$$

$$\%15 = sin ( \%14 )$$

$$outlined\_fun : [ inputs : x ] \qquad Outlined$$

$$\%1 = x$$

$$\%2 = 0.1$$

$$\%3 = 3$$

$$\%4 = ( \%1 \hat{} \%3 )$$

$$original\_expr :$$

$$\%1 = x$$

$$\%2 = outlined\_fun ( \%1 )$$

$$\%3 = outlined\_fun ( \%2 )$$

$$\%4 = outlined\_fun ( \%3 )$$

FIG. 7B depicts an exemplary process for accelerating code generation in a compiler in accordance with an embodiment described herein. The exemplary process for accelerating code generation described in FIG. 7B may be implemented in a compiler or other scientific computing system that uses one or more processors or GPUs. Referring to FIG. 7B, at step 750, a differential-algebraic equation (DAE) is received. The received DAE may be a causal model description or an acausal model description. In various embodiments, the received DAE system may be flattened. In various embodiments, the received DAE system may be represented in linear SSA-IR form.

At step 752, structural information is derived from the received DAE system. The derived structural information includes a bipartite graph of equations and variables. In various embodiments, the derived structural information may further include a variable differentiation graph.

At step 754, a linear subsystem is determined from the model description.

At step 756, the determined linear subsystem is used to find alias variables.

At step 758, a balanced index-1 DAE system is generated. In various embodiments, the balanced index-1 DAE system is generated using the Pantelides algorithm. The Pantelides algorithm may be array-based. In various embodiments, the index reduction lowering steps perform differentiation transformations via bottom-up automatic differentiation.

At step 760, a torn graph is generated from the bipartite graph.

At step 762, the equations and aliases on the torn graph are sorted.

At step 764, the equations are materialized in an SSA-IR form.

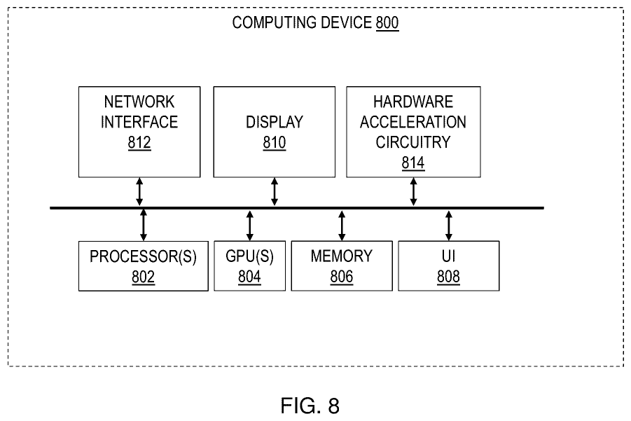

FIG. 8 depicts a block diagram illustrating one embodiment of a computing device that implements the methods and systems described herein. Referring to FIG. 8, the computing device 800 may include at least one processor 802, at least one graphical processing unit (“GPU”) 804, a memory 806, a user interface (“UI”) 808, a display 810, a network interface 812, and hardware acceleration circuitry 814. The memory 806 may be partially integrated with the processor(s) 802, the GPU(s) 804, and/or the hardware acceleration circuitry 814. The hardware acceleration circuitry 814 may be specialized circuitry or hardware specific circuitry, such as an ASIC or FPGA. The UI 808 may include a keyboard and a mouse. The display 810 and the UI 808 may provide any of the GUIs in the embodiments of this disclosure.

The methods described herein may be implemented on one or more computing devices, such as the computing device described in the context of FIG. 8. As described, in one embodiment, a programmatic method for accelerating generation of code in a compiler that preserves structure of the code is disclosed. The programmatic method includes receiving a DAE system. The received DAE system may be a causal model description or an acausal model description. The programmatic method further includes deriving structural information from the received DAE system. The derived structural information includes a bipartite graph of equations and variables. The programmatic method further includes generating a balanced index-1 DAE system. The programmatic method further includes generating a torn graph from the bipartite graph. The programmatic method further includes sorting the equations on the torn graph. The programmatic method further includes materializing the equations as source code for a programming language.

Aspects of the present disclosure may take the form of an entirely hardware embodiment, an entirely software embodiment as a programmatic method (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations for aspects of the present disclosure may be written in any combination of one or more programming languages, including the Julia scientific computing language or an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described above with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These non-transitory computer program instructions may also be stored in a non-transitory computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the present disclosure in the form disclosed. Many modifications and variations will be apparent to those of ordinary skill in the art without departing from the scope and spirit of the present disclosure. The embodiments were chosen and described in order to best explain the principles of the present disclosure and the practical application, and to enable others of ordinary skill in the art to understand the present disclosure for various embodiments with various modifications as are suited to the particular use contemplated.

These and other changes can be made to the disclosure in light of the Detailed Description. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

The subject matter described herein may include the use of machine learning performed by at least one processor of a computing device and stored as non-transitory computer executable instructions (software or source code) embodied on a non-transitory computer-readable medium (memory). Machine learning (ML) is the use of computer algorithms that can improve automatically through experience and by the use of data. Machine learning algorithms build a model based on sample data, known as training data, to make predictions or decisions without being explicitly programmed to do so. Machine learning algorithms are used where it is unfeasible to develop conventional algorithms to perform the needed tasks.

In certain embodiments, instead of or in addition to performing the functions described herein manually, the system may perform some or all of the functions using machine learning or artificial intelligence. Thus, in certain embodiments, machine learning-enabled software relies on unsupervised and/or supervised learning processes to perform the functions described herein in place of a human user.

Machine learning may include identifying one or more data sources and extracting data from the identified data sources. Instead of or in addition to transforming the data into a rigid, structured format, machine learning-based software may load the data in an unstructured format and automatically determine relationships between the data. Machine learning-based software may identify relationships between data in an unstructured format, assemble the data into a structured format, evaluate the correctness of the identified relationships and assembled data, and/or provide machine learning functions to a user based on the extracted and loaded data, and/or evaluate the predictive performance of the machine learning functions (e.g., “learn” from the data).

In certain embodiments, machine learning-based software assembles data into an organized format using one or more unsupervised learning techniques. Unsupervised learning techniques can identify relationship between data elements in an unstructured format.

In certain embodiments, machine learning-based software can use the organized data derived from the unsupervised learning techniques in supervised learning methods to respond to analysis requests and to provide machine learning results, such as a classification, a confidence metric, an inferred function, a regression function, an answer, a prediction, a recognized pattern, a rule, a recommendation, or other results. Supervised machine learning, as used herein, comprises one or more modules, computer executable program code, logic hardware, and/or other entities configured to learn from or train on input data, and to apply the learning or training to provide results or analysis for subsequent data.

Machine learning-based software may include a model generator, a training data module, a model processor, a model memory, and a communication device. Machine learning-based software may be configured to create prediction models based on the training data. In some embodiments, machine learning-based software may generate decision trees. For example, machine learning-based software may generate nodes, splits, and branches in a decision tree. Machine learning-based software may also calculate coefficients and hyper parameters of a decision tree based on the training data set. In other embodiments, machine learning-based software may use Bayesian algorithms or clustering algorithms to generate predicting models. In yet other embodiments, machine learning-based software may use association rule mining, artificial neural networks, and/or deep learning algorithms to develop models. In some embodiments, to improve the efficiency of the model generation, machine learning-based software may utilize hardware optimized for machine learning functions, such as an FPGA.

The systems and methods may support different hardware platforms/architectures, may add implementations for new network layers and new hardware platforms/architectures, and may be optimized in terms of processing, memory and/or other hardware resources for a specific hardware platform/architecture being targeted. Examples of platforms are different GPUs (e.g., Nvidia GPUs, ARM Mali GPUs, AMD GPUs, etc.), different forms of CPUs (e.g., Intel Xeon, ARM, TI, etc.), and programmable logic devices, such as Field Programmable Gate Arrays (FPGAs).

Exemplary target platforms include host computers having one or more single core and/or multicore CPUs and one or more Parallel Processing Units (PPUs), such as Graphics Processing Units (GPUs), and embedded systems including single and/or multicore CPUs, microprocessors, Digital Signal Processors (DSPs), and/or Field Programmable Gate Arrays (FPGAs).

The subject matter described herein may be executed using a distributed computing environment. The environment may include client and server devices, interconnected by one or more networks. The distributed computing environment also may include target platforms. The target platform may include a multicore processor. Target platforms may include a host (Central Processing Unit) and a device (Graphics Processing Unit). The servers may include applications or processes accessible by the clients. The devices of the environment may interconnect via wired connections, wireless connections, or a combination of wired and wireless connections.

The servers may include one or more devices capable of receiving, generating, storing, processing, executing, and/or providing information. For example, servers may include a computing device, such as a server, a desktop computer, a laptop computer, a tablet computer, a handheld computer, or a similar device.

The clients may be capable of receiving, generating, storing, processing, executing, and/or providing information. Information may include any type of machine-readable information having substantially any format that may be adapted for use, e.g., in one or more networks and/or with one or more devices. The information may include digital information and/or analog information. The information may further be packetized and/or non-packetized. In an embodiment, the clients may download data and/or code from the servers via the network. In some implementations, the clients may be desktop computers, workstations, laptop computers, tablet computers, handheld computers, mobile phones (e.g., smart phones, radiotelephones, etc.), electronic readers, or similar devices. In some implementations, the clients may receive information from and/or transmit information to the servers.

The subject matter described herein and/or one or more of its parts or components may comprise registers and combinational logic configured and arranged to produce sequential logic circuits. In some embodiments, the subject matter described herein may be implemented through one or more software modules or libraries containing program instructions pertaining to the methods described herein, that may be stored in memory and/or on computer readable media, and may be executed by one or more processors. Other computer readable media may also be used to store and execute these program instructions. In alternative embodiments, various combinations of software and hardware, including firmware, may be utilized to implement the present disclosure.

The descriptions of the various embodiments of the technology disclosed herein have been presented for purposes of illustration, but these descriptions are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A programmatic method for accelerating generation of code in a compiler that preserves structure of the code, the method comprising:
receiving a differential algebraic equations (DAE) system, wherein the received DAE system is a causal model description or an acausal model description;
deriving structural information from the received DAE system, wherein the derived structural information includes a bipartite graph of equations and variables;
generating a balanced index-1 DAE system;
generating a torn graph from the bipartite graph;
sorting the equations on the torn graph; and
materializing the equations as source code for a programming language.

2. The programmatic method of claim 1, further comprising:
determining a linear subsystem from the model description;
using the determined linear subsystem to find alias variables or to use an exact Gaussian elimination method to simplify the linear subsystem; and
sorting the alias variable on the torn graph.

3. The programmatic method of claim 1, further comprising compiling the materialized source code.

4. The programmatic method of claim 1, wherein the received DAE system is received as a flattened system.

5. The programmatic method of claim 1, wherein the received DAE system is received as a hierarchical system.

6. The programmatic method of claim 1, wherein the received DAE system is represented in linear SSA-IR form.

7. The programmatic method of claim 1, wherein the balanced index-1 DAE system is generated using the Pantelides algorithm.

8. The programmatic method of claim 1, wherein the derived structural information further includes a variable differentiation graph.

9. The programmatic method of claim 1, wherein the generating a balanced index-1 DAE system is performed using bottom-up automatic differentiation.

10. A compiler for accelerating generation of code, the compiler comprising:
one or more hardware processors configured for:
receiving a differential algebraic equations (DAE) system, wherein the received DAE system is a causal model description or an acausal model description;
deriving structural information from the received DAE system, wherein the derived structural information includes a bipartite graph of equations and variables;
generating a balanced index-1 DAE system;
generating a torn graph from the bipartite graph;
sorting the equations on the torn graph; and
materializing the equations as source code for a programming language.

11. The compiler of claim 10, wherein the one or more hardware processors are further configured for:
determining a linear subsystem from the model description;
using the determined linear subsystem to find alias variables or to use an exact Gaussian elimination method to simplify the linear subsystem; and
sorting the alias variables on the torn graph.

12. The compiler of claim 10, wherein the one or more hardware processors is further configured for compiling the materialized source code.

13. The compiler of claim 10, wherein the received DAE system is received as a flattened system.

14. The compiler of claim 10, wherein the received DAE system is received as a hierarchical system.

15. The compiler of claim 10, wherein the received DAE system is represented in linear SSA-IR form.

16. The compiler of claim 10, wherein the programming language is in SSA-IR form.

17. The compiler of claim 10, wherein the balanced index-1 DAE system is generated using the Pantelides algorithm.

18. The compiler of claim 10, wherein the derived structural information further includes a variable differentiation graph.

19. The compiler of claim 10, wherein the generating a balanced index-1 DAE system is performed using bottom-up automatic differentiation.

20. A method for improved code generation performance and runtime efficiency for large-scale models of acausal systems, the method comprising:
using an extended Pantelides algorithm on a single-static assignment intermediate representation (SSA-IR);
using extended alias elimination on the SSA-IR;
using an extended tearing algorithm on the SSA-IR;
generating code for sparse Jacobians via bottom-up automatic differentiation (AD); and
using one or more SSA-IR outlining passes on a lowered acausal model to regain structure of the generated code.
